(19) United States
(12) Patent Application Publication
(10) Pub. No.: US 2026/0200744 A1
(43) Pub. Date: Jul. 16, 2026

(54) METHODS FOR HYDROGENATING CARBON DIOXIDE WITH A ALKALI PROMOTED METAL-OXIDE SUPPORTED CATALYST

(71) Applicant: Saudi Arabian Oil Company, Dhahran (SA)

(72) Inventors: Mohammed A. Al-Daous, Jeddah (SA); Khaled Nafee, Jeddah (SA)

(73) Assignee: Saudi Arabian Oil Company, Dhahran (SA)

(21) Appl. No.: 19/022,450

(22) Filed: Jan. 15, 2025

(51) Int. Cl. C01B 32/40; B01J 21/04; B01J 21/06; B01J 23/04; B01J 23/10; B01J 35/61; B01J 35/63; B01J 37/00; B01J 37/02; B01J 37/08

(52) U.S. Cl. CPC C01B 32/40; B01J 21/04; B01J 21/063; B01J 21/066; B01J 23/04; B01J 23/10; B01J 35/612; B01J 35/613; B01J 35/615; B01J 35/633; B01J 37/0063; B01J 37/0201; B01J 37/0236; B01J 37/08

(57) ABSTRACT

A method of hydrogenating carbon dioxide, the method may include introducing a feed stream comprising carbon dioxide and hydrogen to a reactor. The method may include reacting the carbon dioxide with the hydrogen at a temperature at least 550° C. in the presence of a catalyst to produce carbon monoxide and water. The catalyst may comprises a metal oxide support and a promoter. The promoter may consist of alkali metals. The catalyst may have a carbon monoxide selectivity greater than 90%.

### FIELD

The present disclosure relates to catalysts comprising a metal oxide support and an alkali metal promoter, more specifically, to methods for hydrogenating carbon dioxide in the presence of a catalyst comprising a metal oxide support and an alkali metal promoter.

### TECHNICAL BACKGROUND

The catalytic reduction of carbon dioxide (CO₂) into value-added products represents a promising approach for mitigating CO₂ emissions, particularly when integrated with renewable energy sources. Among the various methods for CO₂ utilization, the reverse water gas shift (RWGS) reaction is especially significant, as it facilitates the production of carbon monoxide (CO). When operated with excess hydrogen, the RWGS reaction generates synthesis gas (syngas), a mixture of hydrogen (H₂) and CO. Syngas serves as a fundamental feedstock for various conversion processes commonly employed in industrial refineries, including Fischer-Tropsch synthesis and the production of alcohols such as methanol, which ranks among the top five chemicals produced globally. The increasing demand for clean fuels and sustainable commodities underscores the importance of highly efficient RWGS processes in the conversion of CO₂. Additionally, RWGS reactors can be effectively integrated into existing infrastructure within heavy carbon industries, such as cement production, steelmaking, and refining.

### SUMMARY

RWGS reaction is an equilibrium reaction favored at high temperatures due to its moderately endothermic character, as well as at high H₂:CO₂ feed ratios, low pressure, and lower contact times. RWGS can be regarded as a process in itself or as an intermediate reaction in other CO₂ conversion processes. For instance, the conversion of CO₂ to methane (CH₄) (e.g., methanation) can occur through a consecutive reaction pathway where the RWGS is the first step. During the RWGS reaction, the formed CO may undergo a hydrogenation reaction to produce methane, which is a facial and energetically favorable reaction because of the higher reactivity of the CO molecule. Hence, CO₂ methanation is considered to be a side reaction affecting the RWGS CO selectivity. Therefore, there is a need for a catalyst with a high selectivity for forming CO via the RWGS reaction. Described herein are catalysts with a high CO selectivity and methods of using those catalysts for hydrogenating carbon dioxide.

According to some embodiments of the present disclosure, a method comprises introducing a feed stream comprising carbon dioxide and hydrogen to a reactor; and reacting the carbon dioxide with the hydrogen at a temperature of at least 550° C. in the presence of a catalyst to produce carbon monoxide and water, wherein the catalyst comprises a metal oxide support and a promoter, the promoter consisting of alkali metals, wherein the catalyst has a carbon monoxide selectivity greater than 90%.

Additional features and advantages of the embodiments described herein will be set forth in the detailed description which follows and, in part, will be readily apparent to those skilled in the art from that description or recognized by practicing the embodiments described, including the detailed description and the claims which are provided herein.

### DETAILED DESCRIPTION

As used herein, “catalyst” refers to any substance that increases the rate of a specific chemical reaction, such as but not limited to hydrogenation reactions.

As used herein, “GHSV” refers to gas-hour-space-velocity.

As used herein, “RWGS” refers to reverse water gas shift.

As used herein, “° C.” refers to degrees Celsius.

As used herein, “mL” refers to milliliters.

As used herein, “g” refers to grams.

As used herein, “cm³” refers to cubic centimeters.

As used herein, “mm” refers to millimeters.

As used herein, “μm” refers to micrometers.

As used herein, “wt. %” refers to weight percent.

As used herein, “bar(g)” refers to the pressure in bars above ambient or atmospheric pressure.

As used herein, “ppm” refers to parts per million.

As used herein, “m²/g” refers to cubic meters per gram.

As used herein, “cm³/g” refers to cubic centimeters per gram.

As used herein, “cm³/min” refers to cubic centimeters per minute.

As used herein, “ml/g/hr” refers to milliliter per gram of catalyst per hour.

Some aspects of the present disclosure are directed to synthesizing a metal oxide-supported alkali-metal catalyst capable of hydrogenating CO₂ to produce CO. These catalyst can have a selectivity for the formation of CO above 90%. Thus, the catalyst may be suitable for the hydrogenation of CO₂ to produce CO via an RWGS reaction. Accordingly, one or more embodiments of the present disclosure are directed to methods for the hydrogenation of CO₂ to produce CO.

### The Metal Oxide Supported Alkali-Metal Catalyst

Catalysts of the present disclosure may comprise an active metal oxide support and an alkali metal promoter. Metal oxide supports can adsorb carbon dioxide irreversibly at temperatures common in RWGS reactions. The alkali metal promoter can enhance the metal oxide support's carbon dioxide uptake. Further, the addition of the alkali metal promoter can limit excessive hydrogenation of CO₂ to form methane. This can be beneficial in RWGS reactions, where the adsorbed carbon dioxide is activated by hydrogen gas to undergo the RWGS reaction to produce carbon monoxide and water. Moreover, catalysts of the present disclosure may be simpler and more cost-effective to produce than previous RWGS catalysts. RWGS catalyst may typically be transition metal or precious metal based. However, transition metals and noble metals can be susceptible to sintering under typical RWGS process conditions (e.g., reaction temperatures). Thus, catalyst of the present disclosure may be more reliable and costs effective because they are not transition metal or precious metal based.

In one or more embodiments, the metal oxide can be selected from the group consisting of aluminum oxide (Al₂O₃), titanium oxide (TiO₂), zirconium oxide (ZrO₂), magnesium oxide (MgO) or cerium oxide (CeO₂).

In one or more embodiments, the alkali metal promoter comprises one or more alkali metals or metal based compounds. In one or more embodiments, the alkali metal and/or alkali metal based compound are selected from the group consisting of lithium, sodium, potassium, rubidium, and cesium. Heavy alkali metals may have a lower tendency to acquire mobility under certain hydrothermal conditions that are common in RWGS reactions. Thus, in some aspects, the preferred alkali metal is potassium. In other aspects, the preferred alkali metal is cesium. In one or more embodiments, the alkali metal can be provided in the form of an elemental metal, a metal nitrate, a metal chloride, a metal carbonate, a metal bicarbonate, a metal benzoate, a metal acetylacetonate, a metal acetylide, or a metal acetylamino succinate. In one or more embodiments, the promoter comprises at least 0.5 wt. %, at least 1 wt. %, at least 1.5 wt. %, at least 2 wt. %, at least 2.5 wt. %, at least 3 wt. %, at least 3.5 wt. %, or at least 4 wt. % of the catalyst, on the basis of the total weight of the catalyst. In one or more embodiments, the promoter comprises no more than 4 wt. % of the catalyst, no more than 3.5 wt. % of the catalyst, no more than 3 wt. % of the catalyst, no more than 2.5 wt. % of the catalyst, no more than 2 wt. % of the catalyst, no more than 1.5 wt. % of the catalyst, no more than 1 wt. % of the catalyst, or no more than 0.5 wt. % of the catalyst, on the basis of the total weight of the catalyst.

### Method of Making the Metal Oxide-Supported Alkali-Metal Catalyst

In one or more embodiments, a method of making the metal oxide supported alkali-metal catalyst can comprise the following steps.

In a first step, an amount of the metal oxide is provided in a powder form. The metal oxide is loaded with an alkali metal by wetness-impregnation or pore-volume wetness impregnation of the metal oxide. In aspects where the metal oxide is loaded with an alkali metal via pore-volume wetness impregnation, a solution of potassium bicarbonate (KHCO₃) and deionized water is formed. The solution is combined with the powdered metal oxide and mixed until a homogenous paste is formed.

In a second step, the paste is dried. The paste may be dried at a temperature from 100° C. to 140° C., from 100° C. to 130° C., from 100° C. to 120° C., from 100° C. to 110° C., from 110° C. to 140° C., from 110° C. to 130° C., from 110° C. to 120° C., from 120° C. to 140° C., from 120° C. to 130° C., from 130° C. to 140° C., or a range where any two listed numbers comprise the endpoints of that range.

The paste may be dried for a time period from 12 hours to 36 hours, from 12 hours to 32 hours, from 12 hours to 28 hours, from 12 hours to 24 hours, from 12 hours to 20 hours, from 12 hours to 16 hours, from 16 hours to 36 hours, from 16 hours to 32 hours, from 16 hours to 28 hours, from 16 hours to 24 hours, from 16 hours to 20 hours, from 20 hours to 36 hours, from 20 hours to 32 hours, from 20 hours to 28 hours, from 20 hours to 24 hours, from 24 hours to 36 hours, from 24 hours to 32 hours, from 24 hours to 28 hours, from 28 hours to 36 hours, from 28 hours to 32 hours, from 32 hours to 36 hours, or a range where any two listed numbers comprise the endpoints of that range.

In a third step, the dried paste is calcined under static air. The dried paste can be calcined at a temperature from 550° C. to 650° C., from 550° C. to 640° C., from 550° C. to 630° C., from 550° C. to 620° C., from 550° C. to 610° C., from 550° C. to 600° C., from 550° C. to 590° C., from 550° C. to 580° C., from 550° C. to 570° C., from 550° C. to 560° C., from 560° C. to 650° C., from 560° C. to 640° C., from 560° C. to 630° C., from 560° C. to 620° C., from 560° C. to 610° C., from 560° C. to 600° C., from 560° C. to 590° C., from 560° C. to 580° C., from 560° C. to 570° C., from 570° C. to 650° C., from 570° C. to 640° C., from 570° C. to 630° C., from 570° C. to 620° C., from 570° C. to 610° C., from 570° C. to 600° C., from 570° C. to 590° C., from 570° C. to 580° C., from 580° C. to 650° C., from 580° C. to 640° C., from 580° C. to 630° C., from 580° C. to 620° C., from 580° C. to 610° C., from 580° C. to 600° C., from 580° C. to 590° C., from 590° C. to 650° C., from 590° C. to 640° C., from 590° C. to 630° C., from 590° C. to 620° C., from 590° C. to 610° C., from 590° C. to 600° C., from 600° C. to 650° C., from 600° C. to 640° C., from 600° C. to 630° C., from 600° C. to 620° C., from 600° C. to 610° C., from 610° C. to 650° C., from 610° C. to 640° C., from 610° C. to 630° C., from 610° C. to 620° C., from 620° C. to 650° C., from 620° C. to 640° C., from 620° C. to 630° C., from 630° C. to 650° C., from 630° C. to 640° C., from 640° C. to 650° C., or a range where any two listed numbers comprise the endpoints of that range.

The dried paste can be calcined for a time period from 3 hours to 7 hours, from 3 hours to 6 hours, from 3 hours to 5 hours, from 3 hours to 4 hours, from 4 hours to 7 hours, from 4 hours to 6 hours, from 4 hours to 5 hours, from 5 hours to 7 hours, from 5 hours to 6 hours, from 6 hours to 7 hours, or a range where any two listed numbers comprise the endpoints of that range.

In a fourth step, to form the catalyst, the calcined product is pressed to form tablets. The calcined product can be pressed at a pressure from 6 tons to 10 tons, from 6 tons to 9 tons, from 6 tons to 8 tons, from 6 tons to 7 tons, from 7 tons to 10 tons, from 7 tons to 9 tons, from 7 tons to 8 tons, from 8 tons to 10 tons, from 8 tons to 9 tons, from 9 tons to 10 tons, or a range where any two listed numbers comprise the endpoints of that range.

The pressed tablets can be crushed and sieved to collect catalyst granules. In some aspects, the crushed tablets are sieved to form granules having a particle size from 200 μm to 500 μm, from 200 μm to 400 μm, from 200 μm to 300 μm, from 300 μm to 500 μm, from 300 μm to 400 μm, from 400 μm to 500 μm, or a range where any two listed numbers comprise the endpoints of that range.

### Methods of Hydrogenating Carbon Dioxide in the Presence of the Metal Oxide Supported Alkali-Metal Catalyst

In one or more embodiments, a method of hydrogenating carbon dioxide to produce carbon monoxide in the presence of the catalyst disclosed herein can comprise the following aspects.

Catalysts prepared as described herein can be packed in a reactor with a packing material to form a catalyst bed. In one or more embodiments, the packing material is provided in the form of silicon carbide. In one or more embodiments, the reactor can be a continuous-flow fixed-bed reactor.

To activate the catalyst, an inert gas can be passed over the catalyst bed as the reactor temperature is raised. In some aspects, the inert gas can be argon gas. The inert gas can be passed over the catalyst bed at a rate of from 50 cm³/min to 100 cm³/min, from 50 cm³/min to 90 cm³/min, from 50 cm³/min to 80 cm³/min, from 50 cm³/min to 70 cm³/min, from 50 cm³/min to 60 cm³/min, from 60 cm³/min to 100 cm³/min, from 60 cm³/min to 90 cm³/min, from 60 cm³/min to 80 cm³/min, from 60 cm³/min to 70 cm³/min, from 70 cm³/min to 100 cm³/min, from, 70 cm³/min to 90 cm³/min, from 70 cm³/min to 80 cm³/min, from 80 cm³/min to 100 cm³/min, from 80 cm³/min to 90 cm³/min, from 90 cm³/min to 100 cm³/min, or a range where any two listed numbers comprise the endpoints of that range.

The temperature of the reactor can be raised at approximately 5° C. per minute until an initial temperature is reached. The initial temperature can be from 550° C. to 750° C., from 550° C. to 700° C., from 550° C. to 650° C., from 550° C. to 600° C., from 600° C. to 750° C., from 600° C. to 700° C., from 600° C. to 650° C., from 650° C. to 750° C., from 650° C. to 700° C., from 700° C. to 750° C., or a range where any two listed numbers comprise the endpoints of that range.

Once the initial temperature is reached, a reaction temperature can be determined and the temperature of the reactor can be raised to the reaction temperature. The temperature of the reactor can be raised at approximately 5° C. per minute until the reaction temperature is reached. The reaction temperature can be from 550° C. to 900° C., from 550° C. to 850° C., from 550° C. to 800° C., from 550° C. to 750° C., from 550° C. to 700° C., from 550° C. to 650° C., from 550° C. to 600° C., from 600° C. to 900° C., from 600° C. to 850° C., from 600° C. to 800° C., from 600° C. to 750° C., from 600° C. to 700° C., from 600° C. to 650° C., from 650° C. to 900° C., from 650° C. to 850° C., from 650° C. to 800° C., from 650° C. to 750° C., from 650° C. to 700° C., from 700° C. to 900° C., from 700° C. to 850° C., from 700° C. to 800° C., from 700° C. to 750° C., from 750° C. to 900° C., from 750° C. to 850° C., from 750° C. to 800° C., from 800° C. to 900° C., from 800° C. to 850° C., from 850° C. to 900° C., or a range where any two listed numbers comprise the endpoints of that range.

During activation of the catalyst, the reactor pressure can be maintained at a target pressure. In one or more embodiments, the target pressure can be greater than 0 bar(g) to 5 bar(g), greater than 0 bar(g) to 4 bar(g), greater than 0 bar(g) to 3 bar(g), greater than 0 bar(g) to 2 bar(g), greater than 0 bar(g) to 1 bar(g), 1 bar(g) to 5 bar(g), from 1 bar(g) to 4 bar(g), from 1 bar(g) to 3 bar(g), from 1 bar(g) to 2 bar(g), 2 bar(g) to 5 bar(g), from 2 bar(g) to 4 bar(g), from 2 bar(g) to 3 bar(g), 3 bar(g) to 5 bar(g), from 3 bar(g) to 4 bar(g), from 4 bar(g) to 5 bar(g), or a range where any two listed numbers comprise the endpoints of that range.

Once the catalyst is activated, a feed stream comprising carbon dioxide and hydrogen can be introduced to the reactor. The carbon dioxide can be hydrogenated through a reverse water gas shift (RWGS) reaction.

In one or more embodiments, the reactor used for hydrogenation of the CO₂ may be operated at a GHSV from 3,000 ml/g/hr to 14,000 ml/g/hr, from 3,000 ml/g/hr to 13,000 ml/g/hr, from 3,000 ml/g/hr to 12,000 ml/g/hr, from 3,000 ml/g/hr to 11,000 ml/g/hr, from 3,000 ml/g/hr to 10,000 ml/g/hr, from 3,000 ml/g/hr to 9,000 ml/g/hr, from 3,000 ml/g/hr to 8,000 ml/g/hr, from 3,000 ml/g/hr to 7,000 ml/g/hr, from 3,000 ml/g/hr to 6,000 ml/g/hr, from 3,000 ml/g/hr to 5,000 ml/g/hr, from 3,000 ml/g/hr to 4,000 ml/g/hr, from 4,000 ml/g/hr to 14,000 ml/g/hr, from 4,000 ml/g/hr to 13,000 ml/g/hr, from 4,000 ml/g/hr to 12,000 ml/g/hr, from 4,000 ml/g/hr to 11,000 ml/g/hr, from 4,000 ml/g/hr to 10,000 ml/g/hr, from 4,000 ml/g/hr to 9,000 ml/g/hr, from 4,000 ml/g/hr to 8,000 ml/g/hr, from 4,000 ml/g/hr to 7,000 ml/g/hr, from 4,000 ml/g/hr to 6,000 ml/g/hr, from 4,000 ml/g/hr to 5,000 ml/g/hr, from 5,000 ml/g/hr to 14,000 ml/g/hr, from 5,000 ml/g/hr to 13,000 ml/g/hr, from 5,000 ml/g/hr to 12,000 ml/g/hr, from 5,000 ml/g/hr to 11,000 ml/g/hr, from 5,000 ml/g/hr to 10,000 ml/g/hr, from 5,000 ml/g/hr to 9,000 ml/g/hr, from 5,000 ml/g/hr to 8,000 ml/g/hr, from 5,000 ml/g/hr to 7,000 ml/g/hr, from 5,000 ml/g/hr to 6,000 ml/g/hr, from 6,000 ml/g/hr to 14,000 ml/g/hr, from 6,000 ml/g/hr to 13,000 ml/g/hr, from 6,000 ml/g/hr to 12,000 ml/g/hr, from 6,000 ml/g/hr to 11,000 ml/g/hr, from 6,000 ml/g/hr to 10,000 ml/g/hr, from 6,000 ml/g/hr to 9,000 ml/g/hr, from 6,000 ml/g/hr to 8,000 ml/g/hr, from 6,000 ml/g/hr to 7,000 ml/g/hr, from 7,000 ml/g/hr to 14,000 ml/g/hr, from 7,000 ml/g/hr to 13,000 ml/g/hr, from 7,000 ml/g/hr to 12,000 ml/g/hr, from 7,000 ml/g/hr to 11,000 ml/g/hr, from 7,000 ml/g/hr to 10,000 ml/g/hr, from 7,000 ml/g/hr to 9,000 ml/g/hr, from 7,000 ml/g/hr to 8,000 ml/g/hr, from 8,000 ml/g/hr to 14,000 ml/g/hr, from 8,000 ml/g/hr to 13,000 ml/g/hr, from 8,000 ml/g/hr to 12,000 ml/g/hr, from 8,000 ml/g/hr to 11,000 ml/g/hr, from 8,000 ml/g/hr to 10,000 ml/g/hr, from 8,000 ml/g/hr to 9,000 ml/g/hr, from 9,000 ml/g/hr to 14,000 ml/g/hr, from 9,000 ml/g/hr to 13,000 ml/g/hr, from 9,000 ml/g/hr to 12,000 ml/g/hr, from 9,000 ml/g/hr to 11,000 ml/g/hr, from 9,000 ml/g/hr to 10,000 ml/g/hr, from 10,000 ml/g/hr to 14,000 ml/g/hr, from 10,000 ml/g/hr to 13,000 ml/g/hr, from 10,000 ml/g/hr to 12,000 ml/g/hr, from 10,000 ml/g/hr to 11,000 ml/g/hr, from 11,000 ml/g/hr to 14,000 ml/g/hr, from 11,000 ml/g/hr to 13,000 ml/g/hr, from 11,000 ml/g/hr to 12,000 ml/g/hr, from 12,000 ml/g/hr to 14,000 ml/g/hr, from 12,000 ml/g/hr to 13,000 ml/g/hr, from 13,000 ml/g/hr to 14,000 ml/g/hr, or a range where any two listed numbers comprise the endpoints of that range.

In one or more embodiments, the ratio of carbon dioxide to hydrogen in the feed stream can be 0.5:5, 0.5:4.5, 0.5:4, 0.5:3.5, 0.5:3, 0.5:2.5, 0.5:2, 0.5:1.5, 0.5:1, 1:5, 1:4.5, 1:4, 1:3.5, 1:3, 1:2.5, 1:2, 1:1.5, 1.5:5, 1.5:4.5, 1.5:4, 1.5:3.5, 1.5:3, 1.5:2.5, 1.5:2, 2:5, 2:4.5, 2:4, 2:3.5, 2:3, 2:2.5, 2.5:5, 2.5:4.5, 2.5:4, 2.5:3.5, 2.5:3, 3:5, 3:4.5, 3:4, 3:3.5, 3.5:5, 3.5:4.5, 3.5:4, 4:5, 4.5:5, or a range where any two listed numbers comprise the endpoints of that range.

As the feed stream contacts the catalyst, the carbon dioxide and hydrogen react to produce carbon monoxide, water, unreacted carbon dioxide (e.g., waste carbon dioxide), and unreacted hydrogen (e.g., waste hydrogen). As discussed herein, the metal oxide-supported alkali-metal catalyst can have a high CO selectivity. In one or more embodiments, the catalyst can have a CO selectivity of at least 90%, at least 91%, at least 92%, at least 93%, at least 94%, at least 95%, at least 96%, at least 97%, at least 98%, at least 99%, or at least 99.9%.

In one or more embodiments, the RWGS reaction can have a CO₂ conversion percentage of at least 45%, at least 50%, at least 55%, at least 60%, at least 65%, at least 70%, at least 75%, at least 80%, or at least 85%.

In one or more embodiments, the produced carbon monoxide can be removed from the reactor as a product stream. In some aspects, the product carbon monoxide can be provided to a secondary reactor designed to use the carbon monoxide in a process selected from the group consisting of a Fischer-Tropsch synthesis process and an alcohol synthesis process. In one or more embodiments, some or all of the waste carbon dioxide stream can be provided to a secondary reactor designed to use the product stream in a process selected from the group consisting of a Fischer-Tropsch synthesis process and an alcohol synthesis process.

In one or more embodiments, some or all of the waste carbon dioxide stream can be recycled back to the reactor for further processing. Similarly, in one or more embodiments, some or all of the waste hydrogen stream can be recycled back to the reactor for further processing.

This disclosure includes numerous aspects. One aspect is a method of hydrogenating carbon dioxide, the method comprising: introducing a feed stream comprising carbon dioxide and hydrogen to a reactor; and reacting the carbon dioxide with the hydrogen at a temperature at least 550° C. in the presence of a catalyst to produce carbon monoxide and water, wherein the catalyst comprises a metal oxide support and a promoter, the promoter consisting of alkali metals, wherein the catalyst has a carbon monoxide selectivity greater than 90%.

A second aspect of the present disclosure may include any above aspect or combination of aspects, wherein the catalyst has a carbon monoxide selectivity greater than 99%.

A third aspect of the present disclosure may include any above aspect or combination of aspects, wherein the promoter comprises one or more alkali metals or metal based compounds, the alkali metal being selected from the group consisting of lithium, sodium, potassium, rubidium, and cesium.

A fourth aspect of the present disclosure may include any above aspect or combination of aspects, wherein the promoter is provided in the form of an elemental metal, a metal nitrate, a metal chloride, a metal carbonate, a metal bicarbonate, a metal benzoate, a metal acetylacetonate, a metal acetylide, or a metal acetylamino succinate.

A fifth aspect of the present disclosure may include any above aspect or combination of aspects, wherein the metal oxide support is selected from the group consisting of aluminum oxide (Al₂O₃), titanium oxide (TiO₂), zirconium oxide (ZrO₂), magnesium oxide (MgO) and cerium oxide (CeO₂).

A sixth aspect of the present disclosure may include any above aspect or combination of aspects, wherein the catalyst comprises at least 1 wt. % of the promoter.

A seventh aspect of the present disclosure may include any above aspect or combination of aspects, wherein the catalyst comprises up to 4 wt. % of the promoter.

An eighth aspect of the present disclosure may include any above aspect or combination of aspects, wherein the reactor comprises a continuous flow fixed-bed reactor.

A ninth aspect of the present disclosure may include any above aspect or combination of aspects, wherein a molar ratio of the carbon dioxide to the hydrogen in the feed stream is 0.5:5.

A tenth aspect of the present disclosure may include any above aspect or combination of aspects, wherein the reactor is operated at a temperature from 550° C. to 900° C.

An eleventh aspect of the present disclosure may include any above aspect or combination of aspects, wherein the reactor is operated at a pressure from greater than 0 bar(g) to 5 bar(g).

A twelfth aspect of the present disclosure may include any above aspect or combination of aspects, wherein the feed stream is provided to the reactor at a gas-hour-space-velocity from 3,000 mL/g/hr to 14,000 mL/g/hr.

A thirteenth aspect of the present disclosure may include any above aspect or combination of aspects, wherein the catalyst is heated under a flow of an inert gas at a temperature of 550° C. to 750° C. for a time period of at least one hour prior to introducing the feed stream to the reactor.

A fourteenth aspect of the present disclosure may include any above aspect or combination of aspects, wherein the carbon monoxide product is utilized in a secondary reactor as a reactant in a process selected from the group consisting of a Fischer-Tropsch synthesis process and an alcohol synthesis process.

A fifteenth aspect of the present disclosure may include any above aspect or combination of aspects, wherein unreacted carbon dioxide from the feed stream is recycled back to the reactor.

A sixteenth aspect of the present disclosure may include any above aspect or combination of aspects, wherein unreacted hydrogen from the feed stream is recycled back to the reactor.

A seventeenth aspect of the present disclosure may include any above aspect or combination of aspects, reacting the carbon dioxide with the hydrogen produces a waste hydrogen stream comprised of unreacted hydrogen from the feed stream, and wherein the waste hydrogen stream is provided to a secondary reactor designed to use the waste hydrogen stream in a process selected from the group consisting of a Fischer-Tropsch synthesis process and an alcohol synthesis process.

### EXAMPLES

The various aspects of the present disclosure will be further clarified by the following examples. The examples are illustrative in nature and should not be understood to limit the subject matter of the present disclosure.

### Comparative Example 1 (CE-1)

A catalyst comprising Gamma-alumina powder (γ-Al₂O₃, obtained from Thermo Scientific Chemical®) with a surface area of 206 m²/g and pore volume of 0.362 cm³/g was calcined at 600° C. for 5 hours under static air prior to catalytic testing.

### Inventive Example 1 (IE-1)

A catalyst comprising 3% K/γ-Al₂O₃ was prepared according to the following method. First, 10.0 g of gamma-alumina powder (γ-Al₂O₃, obtained from Thermo Scientific Chemical®) with a surface area of 206 m²/g and a pore volume of 0.362 cm³/g was loaded with 3.0 wt. % potassium (K) using a pore-volume wetness impregnation method. In the method, 0.792 grams of potassium bicarbonate (KHCO₃ at a concentration of 99.5-101.0%, obtained from Merck Pharmaceuticals®) was dissolved in 4.5 mL of deionized water. The solution was added to the solid alumina and mixed until a homogenous paste was obtained. The paste was dried at 120° C. for 24 hours. The dried sample was then calcined at 600° C. for 5 hours under static air. The resulting catalyst had a surface area of 202 m²/g and a pore volume of 0.344 cm³/g.

### Inventive Example 2 (IE-2)

A catalyst comprising 3% K/TiO₂ was prepared according to the following method. First, 10.0 g of titanium oxide powder (TiO₂, anatase, 99.9%, obtained from Thermo Scientific®) with a surface area of 45 m²/g was loaded with 3.0 wt. % K using pore-volume wetness impregnation method. In the method, 3.96 mL of 2.0 Molar potassium bicarbonate solution (KHCO₃, 99.5-101.0%, obtained from Merck Pharmaceuticals®) was added to the solid titania and mixed until a homogenous paste was obtained. The paste was dried at 120° C. for 24 hours. The dried sample was calcined at 600° C. for 5 hours under static air. The resulting catalyst had a surface area of 40 m²/g and a pore volume of 0.13 cm³/g.

### Inventive Example 3 (IE-3)

A catalyst comprising 3% K/MgO was prepared according to the following method. First, 10.0 g of magnesium oxide powder (MgO, obtained from Pharmaceuticals®) with a surface area of 21.1 m²/g and a pore volume of 0.154 cm³/g was loaded with 3.0 wt. % K using a pore-volume wetness impregnation method. In the method, 3.95 mL of 2.0 Molar KHCO₃ solution (99.5-101.0%, obtained from Merck Pharmaceuticals®) was added to the solid magnesia and mixed until a homogenous paste was obtained. The paste was dried at 120° C. for 24 hours. The dried sample was calcined at 600° C. for 5 hours under static air. The resulting catalyst had a surface area of 28.13 m²/g and a pore volume of 0.308 cm³/g.

### Inventive Example 4 (IE-4)

A catalyst comprising 3% K/ZrO was prepared according to the following method. First, 10.0 g of zirconium oxide powder (ZrO2, obtained from Fisher Chemical®) with a surface area of 9.3 m²/g and a pore volume of 0.021 cm³/g was loaded with 3.0 wt. % K using a pore-volume wetness impregnation method. In the method, 3.95 mL of 2.0 Molar KHCO₃ solution (99.5-101.0%, obtained from Merck Pharmaceuticals®) was added to the solid zirconia and mixed until a homogenous paste was obtained. The paste was dried at 120° C. for 24 hours. The dried sample was calcined at 600° C. for 5 hours under static air. The resulting catalyst had a surface area of 5.2 m²/g and a pore volume of 0.019 cm³/g.

### Inventive Example 5 (IE-5)

A catalyst comprising 3% K/CeO₂ was prepared according to the following method. First, 10.0 g of cerium oxide powder (CeO₂, obtained from Thermo Scientific Chemical®) with a surface area of 7.85 m²/g and a pore volume of 0.045 cm³/g was loaded with 3.0 wt. % K using pore-volume wetness impregnation method. In the method, 3.95 mL of 2.0 Molar KHCO₃ solution (99.5-101.0%, obtained from Merck Pharmaceuticals®) was added to the solid ceria and mixed until a homogenous paste was obtained. The paste was dried at 120° C. for 24 hours. The dried sample was calcined at 600° C. for 5 hours under static air prior to catalytic testing. The resulting catalyst had a surface area of 3.47 m²/g and a pore volume of 0.016 cm³/g.

### Preparation and Activation of the Catalyst

The catalyst formulations described above (e.g., EX-1 to EX-5) were prepared and activated according to the following method. The catalysts, as prepared in examples EX-1 to EX-5, were pressed at 8 tons of pressure to form tablets. The tablets were crushed and sieved to form 200-500 μm granules. The granules had an approximate volume of 1.5 cm³ and a weight of 0.50 g. The granules were packed with silicon carbide into a tubular Hastelloy-X reactor that had a length of 310 mm and an internal diameter of 9.1 mm. The reactor had a thermocouple immersed into the catalyst bed. Argon gas was passed over the catalyst at a rate of approximately 75 cm³/min, and the reactor's temperature was raised to 650° C. at a rate of 5 degrees Celsius per minute. The temperature was changed to the selected reaction temperature at a rate of 5 degrees per minute.

### Testing of the Catalyst

The activated catalysts of examples EX-1 to EX-5 were tested for the hydrogenation of carbon dioxide through a reverse water gas shift (RWGS) reaction in a continuous flow fixed-bed reactor. The reaction was carried out at a temperature of 750° C., over 0.5 g of catalyst, under atmospheric pressure, a CO₂ to H₂ feed ratio ranging from 1:1 to 1:5, and a GHSV of 6600 mL/g/hr.

TABLE 1
Catalyst Performance in a RWGS Reaction

| Sample | Ratio of CO₂ to H₂ in | CO₂ Conversion, | Methane | CO Selectivity, |
|---|---|---|---|---|
| Name | Reactor Feed Stream | (%) | Selectivity, (ppm) | (%) |
| CE-1 | 1:1 | 29.57 | 20 | 99.998 |
| | 1:2 | 40.09 | 78 | 99.992 |
| | 1:3 | 47.09 | 172 | 99.983 |
| | 1:4 | 52.36 | 283 | 99.972 |
| | 1:5 | 56.47 | 400 | 99.960 |
| IE-1 | 1:1 | 45.12 | 8 | 99.999 |
| | 1:2 | 60.83 | 29 | 99.997 |
| | 1:3 | 69.39 | 76 | 99.992 |
| | 1:4 | 74.83 | 150 | 99.985 |
| | 1:5 | 78.59 | 216 | 99.978 |
| IE-2 | 1:1 | 45.67 | 25 | 99.997 |
| | 1:2 | 61.60 | 26 | 99.997 |
| | 1:3 | 70.31 | 49 | 99.995 |
| | 1:4 | 75.35 | 89 | 99.991 |
| | 1:5 | 79.58 | 132 | 99.987 |
| IE-3 | 1:1 | 45.05 | 82 | 99.992 |
| | 1:2 | 61.42 | 76 | 99.992 |
| | 1:3 | 70.44 | 96 | 99.990 |
| | 1:4 | 76.08 | 137 | 99.986 |
| | 1:5 | 79.87 | 184 | 99.982 |
| IE-4 | 1:1 | 45.10 | 33 | 99.997 |
| | 1:2 | 61.63 | 30 | 99.997 |
| | 1:3 | 70.46 | 47 | 99.995 |
| | 1:4 | 75.93 | 89 | 99.991 |
| | 1:5 | 79.55 | 144 | 99.986 |
| IE-5 | 1:1 | 45.64 | 81 | 99.992 |
| | 1:2 | 61.82 | 57 | 99.994 |
| | 1:3 | 70.50 | 76 | 99.992 |
| | 1:4 | 75.82 | 105 | 99.989 |
| | 1:5 | 79.49 | 141 | 99.986 |

As shown in Table 1, for each example (e.g., comparative example CE-1 and inventive examples IX-1 to IX-5), the CO selectivity for CO formation increased as the ratio of CO₂ to H₂ in the reactor feed stream decreased. The CO₂ conversion percentage increased as the ratio of CO₂ to H₂ in the reactor feed stream increased, and approached equilibrium conversion values. However, comparative example CE-1 exhibited a lower CO₂ conversion % as compared to the inventive examples IX-1 to IX-5. Thus, the inventive examples IX-1 to IX-5 were able to achieve the desired CO selectivity and a higher CO₂ conversion % as compared to a catalyst that did not include an alkali metal.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

Herein, ranges are provided. It is envisioned that each discrete value encompassed by the ranges is also included. Additionally, the ranges that may be formed by each discrete value encompassed by the explicitly disclosed ranges are equally envisioned.

The singular forms “a,” “an,” and “the” include plural referents unless the context clearly dictates otherwise.

As used herein and in the appended claims, the words “comprise,” “has,” “include,” and all grammatical variations thereof are each intended to have an open, non-limiting meaning that does not exclude additional elements or steps.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

1. A method of hydrogenating carbon dioxide, the method comprising:
introducing a feed stream comprising carbon dioxide and hydrogen to a reactor; and
reacting the carbon dioxide with the hydrogen at a temperature at least 550° C. in the presence of a catalyst to produce carbon monoxide and water, wherein the catalyst comprises a metal oxide support and a promoter, the promoter consisting of alkali metals,
wherein the catalyst has a carbon monoxide selectivity greater than 90%.

2. The method of claim 1, wherein the catalyst has a carbon monoxide selectivity greater than 99%.

3. The method of claim 1, wherein the promoter comprises one or more alkali metals or metal based compounds, the one or more alkali metals or metal based compounds being selected from the group consisting of lithium, sodium, potassium, rubidium, and cesium.

4. The method of claim 3, wherein the promoter is provided in the form of an elemental metal, a metal nitrate, a metal chloride, a metal carbonate, a metal bicarbonate, a metal benzoate, a metal acetylacetonate, a metal acetylide, or a metal acetylamino succinate.

5. The method of claim 1, wherein the metal oxide support is selected from the group consisting of aluminum oxide (Al₂O₃), titanium oxide (TiO₂), zirconium oxide (ZrO₂), magnesium oxide (MgO) and cerium oxide (CeO₂).

6. The method of claim 1, wherein the catalyst comprises at least 1 wt. % of the promoter.

7. The method of claim 1, wherein the catalyst comprises up to 4 wt. % of the promoter.

8. The method of claim 1, wherein the reactor comprises a continuous flow fixed-bed reactor.

9. The method of claim 1, wherein a molar ratio of the carbon dioxide to the hydrogen in the feed stream is 0.5:5.

10. The method of claim 1, wherein the reactor is operated at a temperature from 550° C. to 900° C.

11. The method of claim 1, wherein the reactor is operated at a pressure from greater than 0 bar(g) to 5 bar(g).

12. The method of claim 1, wherein the feed stream is provided to the reactor at a gas-hour-space-velocity from 3,000 mL/g/hr to 14,000 mL/g/hr.

13. The method of claim 1, wherein the catalyst is heated under a flow of an inert gas at a temperature of 550° C. to 750° C. for a time period of at least one hour prior to introducing the feed stream to the reactor.

14. The method of claim 1, wherein the carbon monoxide product is utilized in a secondary reactor as a reactant in a process selected from the group consisting of a Fischer-Tropsch synthesis process and an alcohol synthesis process.

15. The method of claim 1, wherein unreacted carbon dioxide from the feed stream is recycled back to the reactor.

16. The method of claim 1, wherein unreacted hydrogen from the feed stream is recycled back to the reactor.

17. The method of claim 1, wherein reacting the carbon dioxide with the hydrogen produces a waste hydrogen stream comprised of unreacted hydrogen from the feed stream, and wherein the waste hydrogen stream is provided to a secondary reactor designed to use the waste hydrogen stream in a process selected from the group consisting of a Fischer-Tropsch synthesis process and an alcohol synthesis process.
